(19) United States
(12) Patent Application Publication
(10) Pub. No.: US 2012/0282914 A1
(43) Pub. Date: Nov. 8, 2012

(54) SMART PHONE COMPANION LOOP

(76) Inventor: Lael Andrew Alexander, Sugerland, TX (US)

(21) Appl. No.: 13/443,796

(22) Filed: Apr. 10, 2012

Related U.S. Application Data
(63) Continuation-in-part of application No. 61/483,451, filed on May 6, 2011.

(51) Int. Cl. H04W 4/00

(52) U.S. Cl. 455/420

(57) ABSTRACT

A smart phone companion loop is presented as a phone companion solution that extends the use of a mobile device to the loop tablet or compatible computing device by pairing functionality of both devices. The loop tablet operates as a standalone or parallel device, allowing user to operate applications and functionality from either of the paired devices. The loop tablet allows users to view smart phone applications on a larger screen setting wirelessly. Loop connectivity is the seamless integration of one or more paired mobile devices that communicate wirelessly and share total functionality when tethered or synced with bi-directional control and interface between looped devices with functional commands from both devices. Tablet and Cell phone will be ‘paired’ for security reasons. It may be possible to pair a tablet, car or computing device with multiple or more registered phones that operates under a standard or custom operating system.

### CROSS REFERENCE TO RELATED APPLICATIONS

This application claims the benefit of Provisional Application Ser. No. 61/483,451 filed May 6, 2011 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in cellular phone complementary products. More particularly, the present smart phone companion loop connects between a cellular phone and a device with a larger display computing device and provides bi-directional access and functionality between the two devices.

Description of Related Art including information disclosed under 37 CFR 1.97 and 1.98.

Consumers are inundated with a host of smart phones that advance communication dialog. Markets have been created to group consumer markets by segmenting market desires and curving buying patterns. As a result, consumers are led to constantly update or purchase new products that by and large fall short of total fulfillment leaving them to either purchase a product from each market leader. As an example, users who own a blackberry or windows phone for business purchase and I phone for entertainment, or android for flexibility 2 Phone User Trend.

Consumers are utilizing the computing power of their phone more frequently today than ever before. This trend causes tremendous discomfort to the user in regards to eye strain, ease of use and in some cases the cost burden of administering additional data plans. Typical solutions have been to email data between devices to view or use the resources of one device individually be either compromising the screen size, functions or connectivity of the device.

A number of patents have been issued that provide limited solutions to dealing with the small screen and limited access to the phone features because of the small screen and limited ability to read the small text. Exemplary examples of patents that have been issued that try to address this problem are identified and discussed below.

U.S. Publication number 2006/0245415 that published on Nov. 2, 2006 to Keith Gerard Krasnansky discloses a system for adding PC Screen Sharing to a Telephone Call. This publication provides on one directional transmission of a first PC screen onto the screen of a second computer screen with a phone call. The communication is only unidirectional and only allows viewing without the ability to interact with the PC.

U.S. Publication 2009/0147758 that was published on Jun. 11, 2009 to Avi Kumar discloses a Mobile Internet Device with a Detachable Wireless Module. The disclosure is a base PC unit with a dockable mobile communication device or cellular phone. Data between the two devices must be synchronized or dragged and dropped between the two devices thereby only allowing one device to be operable at a time. There is not an active link loop between the two devices to allow either device to be used collectively or independently.

U.S. Publication number 2011/0059769 that was published on Mar. 10, 2011 to Michael J Brumolli discloses a Remote Phone Manager. The manager allows the limited transfer of information from a phone and a PC or a watch. The limited information is sent only in one direction from the cellular phone. The information is only the phone number or contact information from the person who is calling.

What is needed is device or application that provides bidirectional communication between a cellular phone and a distal computing device to allow full access and use of the cellular device from the distal computing device. The full access is to utilize all of the functions of the cellular phone with a larger easier to read display and still allows the cellular phone and the computing device to operate as looped and or independent units.

### BRIEF SUMMARY OF THE INVENTION

It is an object of the smart phone companion loop to be a phone companion solution that extends the use of a mobile device to the Loop Tablet or compatible computing device by pairing functionality of both devices. The Loop Tablet operates as a standalone or parallel device, allowing user to operate applications and functionality from either of the paired devices. The loop tablet allows users to view smart phone applications on a larger screen setting wirelessly.

It is an object of the smart phone companion loop to be a device or application that functions as a universal remote control and extended display device for smart phones and IP devices. Loop connectivity is the seamless integration of one or more paired mobile devices that communicate wirelessly and share total functionality when tethered or synced with bi-directional control and interface between looped devices with functional commands from both devices.

It is an object of the smart phone companion loop to function as software, firmware or hardware that runs on existing computing or tablet hardware to mirror the cell-phone UI on the tablet or computing device i.e. the cell phone user interface is operated with Tablet touch screen or computing device with a mouse, touch pad, pen, touch pad, track ball or similar user interface device.

It is an object of the smart phone companion loop to pair with a compatible tablet or computing device. Tablet and Cell phone will be ‘paired’ for security reasons. It may be possible to pair a tablet or computing device with multiple or more registered phones that operates under a standard or custom operating system.

It is an object of the smart phone companion loop to provide an extension and expansion of mobile communication devices and display function and access to content through the cellular phone including but not limited to phone calls, games and internet access. In addition the nesting environment enables PC's, smart phones, portable games and other controllers to be featured and hosted through a multi wireless protocol with a viewing within the display of the companion device.

It is another object the smart phone companion loop to enable the embodiment and function of one mobile device to be extended to a separate device through IP, wireless, Wi-Fi, IR, FM or Bluetooth connectivity between looped devices. This connection allows for a smart phone companion loop to modulate control functions of external communication devices through an interlaced multi wireless protocol.

It is another object the smart phone companion loop to operate either above or below the operating system of the looped devices. When the loop exists within the operating system it can be integrated in the operating system of the device. When the loop exists above the operating system it can operate as an application or user selectable program.

Various objects, features, aspects, and advantages of the present smart phone companion loop will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a cellular phone looped to a table computing device.

FIG. 2 shows a flow chart of the looping action.

FIG. 3 shows a block diagram of a tablet computing device

FIG. 4 shows a block diagram of the cell phone and tablet communication links.

FIG. 5 shows a pictorial diagram of operation with multiple workspaces.

FIG. 6 shows a block diagram of the system architecture.

FIG. 7 shows a block diagram of the operating applications and where the software/hardware features were developed to interface.

FIG. 8 shows a block diagram of the system Firmware/software architecture.

FIG. 9 shows a block diagram of the system hardware.

FIG. 10 shows an exploded view of a tablet computing device that can be looped to a cellular phone.

FIG. 11 shows a side view with the controls and connection port.

FIG. 12 shows a tablet style computing device that can be looped with a cellular phone.

FIG. 13 shows a block diagram of tablet connections and hardware interfaces.

FIG. 14 shows a pictorial diagram of the tablet interfacing with other engines.

FIG. 15 shows a pictorial diagram of user's tablet with connection/interface options.

FIG. 16 shows a pictorial diagram of the tablet connection interfacing.

FIG. 17 shows a pictorial diagram of tablet(s) access to a network and other devices and people.

FIG. 18A-18L show twelve different screen display options.

FIG. 19 shows computer screen with three looped devices shown on the same screen.

### DETAILED DESCRIPTION OF THE INVENTION

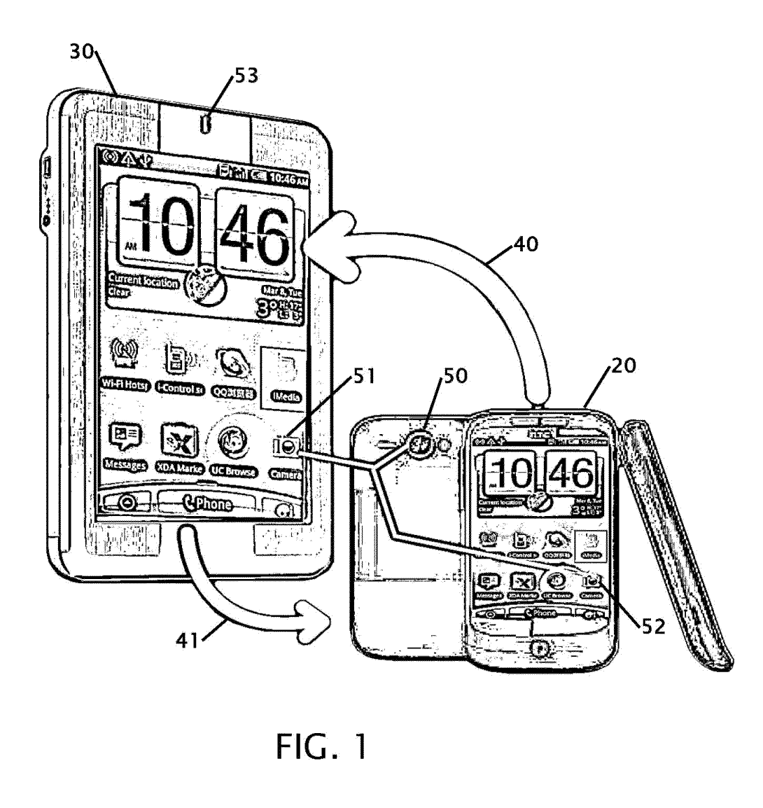

FIG. 1 shows a perspective view of a cellular phone looped to a table computing device. In this preferred embodiment the screen of a cellular device or phone 20 is shown on a tablet computing device 30. In other preferred embodiment the screen of a cellular device or phone can be shown on the display of a laptop, desktop or other computing device. The devices and the screens are looped 40, 41 together thereby enabling display and user interaction with equal control between the two devices. The term Loop or Looping is used to describe the utility application that enables users to mirror cell phone user interfaces with an interactive touch screen. Control of the tablet 30 can be performed with a finger or stylus. If the cellular device or phone 20 is looped with a device that does not have a touch screen, a mouse or similar user input device can be used to provide input for selection. All or nearly all of the functions of the cellular phone 20 are looped to the tablet or other computing device.

The camera function can be activated by either the camera function 51 on the tablet computing device or the camera function 52 on the phone itself. In this figure the camera 50 function is identified. In this example, the camera 50 exists on the back of the phone 20. Because the camera 50 exists on the back of the phone 20, the image is viewable from the screen of the phone 20. When the phone 20 is looped, the image from the camera 20 will also be visible on the tablet 30 or other computing device. The shutter control can be activated by either the phone 20 and or by the looped computing device 30. The IR sensor 53 allows for control of IR devices such as but not limited TV control, lighting controls and garage remote controls.

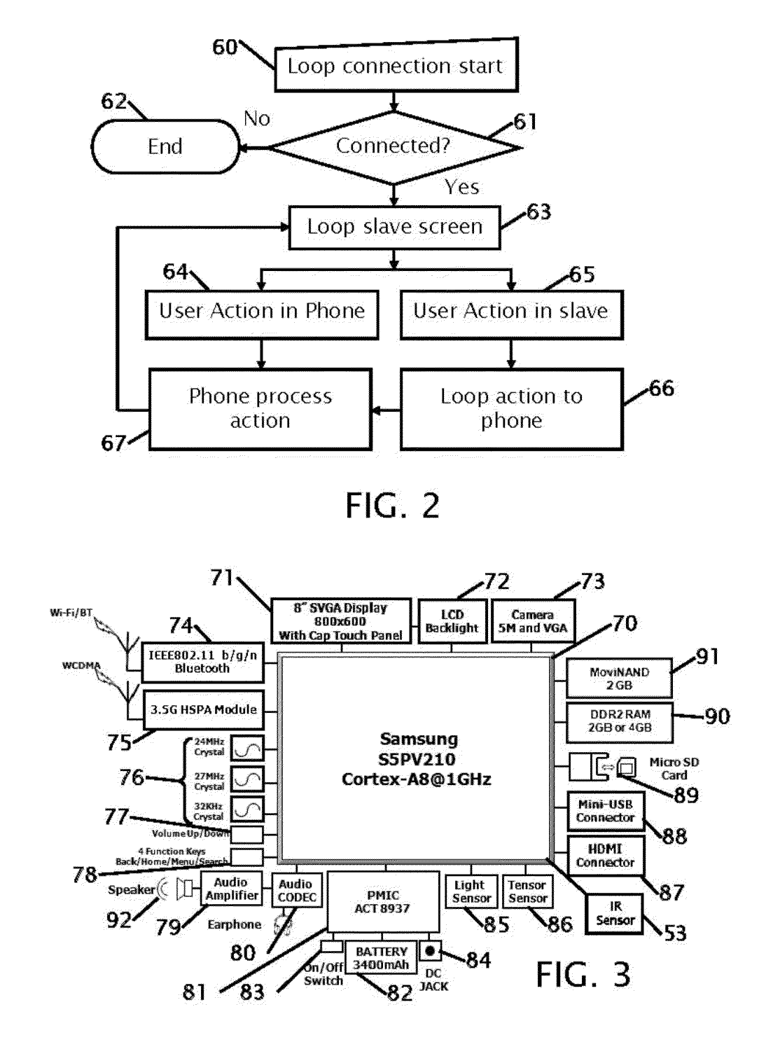

FIG. 2 shows a flow chart of the looping action. The loop is initiated 60 when one phone 20 or the computing device 30 requests a connection. The two devices can be local where they are looped by a physical wired connection, or can be distal where they are looped through a wireless connection. Depending upon the distance between the devices the looped connection can be made from a variety of methods that can be different. For example the cellular phone can link to the internet through a G3, G4 or other wireless internet connection, while the computing device can be looped to the phone using a Wi-Fi connection at a coffee shop on the other side of the world. The tablet or other computing device may not have cellular connection capability to be looped or to use the cellular capabilities of the phone including but not limited to voice calling, pictures, movie watching, internet access, games, music files or any of the capabilities that can exist within the cellular phone.

In another example the tablet, PC or automobile display 30 can make a phone call through the phone 20 without having the phone within Bluetooth, Wi-Fi or other directly linked range. The loop between the two devices can be from one or more of the following methods including but not limited to wired, wireless, Wi-Fi, IR, FM or Bluetooth. The priority of the connected or looped devices is based upon availability, proximity and power consumption. If a connection between the two devices is not possible then the connection is not established or ends 62. Once the devices are connected 61 or looped the screen from the cellular device is looped to the slave screen or a window on the slave device 63. Depending upon the screen resolution of the slave device the display on the tablet or other computing device can exist in a window, be cropped or expanded.

If a user takes action with the phone 64 the phone processes the action 67 and loops the updated screen to the slave 63. If a user takes action with the slave 65, the action is looped to the phone 66 where again the phone processes the action 67 and loops the updated screen to the slave 63. This looped process allows access to the features and functions of the phone as well as making and receiving phone calls on the looped tablet even though the table or other computing device does not have cell phone or internet access. All computations for the phone functions take place within the phone thereby reducing power consumption on the tablet because it simply operates to maintain display and tactile type user input.

The loop program can be integrated into the operating system of the cellular and or communication device where it is embedded within the device or exist as an application or program above the operating system. FIG. 3 shows a block diagram of a tablet computing device where the looping program is embedded into the tablet. In this example various components and capabilities are described with specific size, shape or performance capabilities. These are examples and devices or components with lesser, equivalent or superior capability are contemplated as technology advances without departing from the inventive concepts herein. In this contemplated embodiment the CPU 70 is an ARM Cortex-A8 CPU Running at 800 MHz or 1 GHz but could be a variety of single or multiple core CPU's. One form of memory 90 is contemplated as 2 GB or more of Flash storage. Another form of contemplated memory 91 is DDR2 Ram configures as 1 Gbits×4 (64M words×16 bits) or more. This embodiment shows an 8-inch TFT display 71 with a resolution of 800×600 SVGA with backlight 72 controls having capacitive, resistive or inductive single or multi-touch sensitivity. Larger or smaller size displays with greater or lesser resolution are contemplated. A still and or VGA movie camera 73 is also contemplated.

Options for connection 74 to the phone are contemplates as being with HSUPA, HSDPA, UMTS, WCDMA 3G modem module and Wireless Connectivity IEEE802.11b/g/n Wireless LAN 75. Options for BT2.1 as well as GPS can be integrated. A variety of clocks for internal processing, time keeping and communications are contemplated 76. A series of user interface controls 77 and 78 allows the table to be uses separately from the cellular phone. It is further contemplated that multiple tablets can be looped together to create a larger screen that spans across multiple tablets. These screens can operate together as a larger single screen or a multiple independently linked screens to allow two or more separate individuals to interact with the screen and functions of the phone.

The mobile tablet device display synchronizes voice, video and data from an end user's current mobile phone or smart phone access point and allows single end user or multiple end users to view and communicate through a larger audio visual display.

The loop is web enabled and with Wi-Fi built in. The loop can operate as a stand-alone web enabled internet viewer/controller with built-in Wi-Fi or as an extension of video display capacity to a mobile phone.

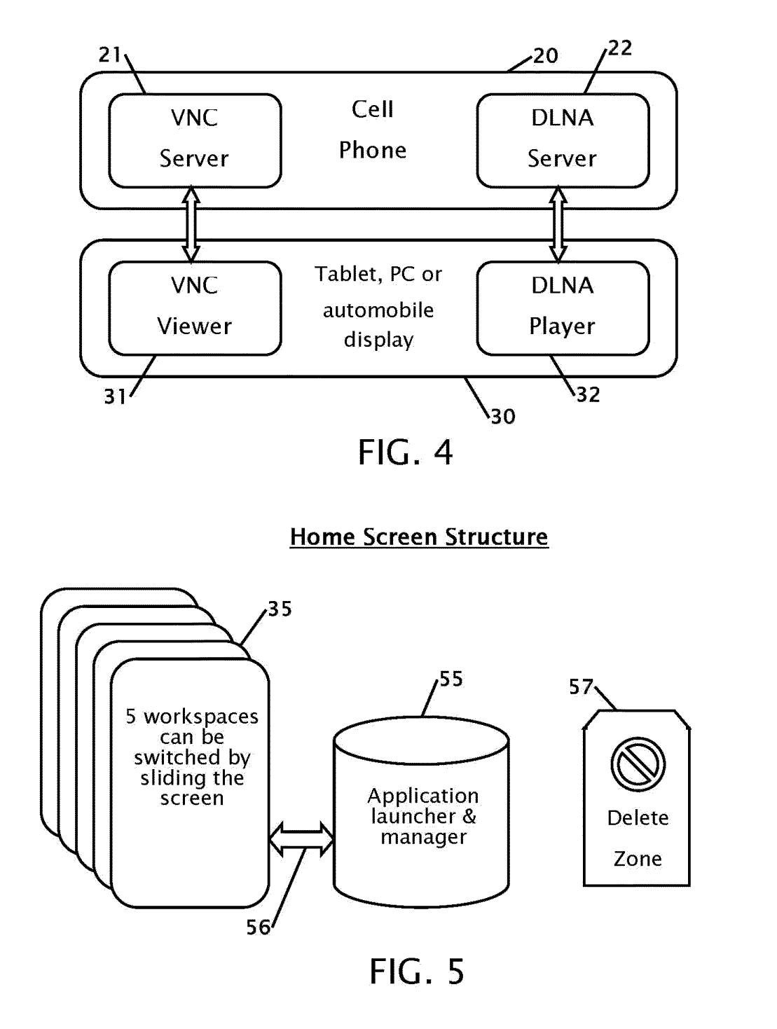

FIG. 4 shows a block diagram of the cell phone and tablet communication links and FIG. 5 shows a pictorial diagram of operation with multiple workspaces. The Cell phone 20 provides the server of the VNC 21 and the DLNA 22. The tablet, PC or automotive display 30 operates as a VNC viewer 31 and a DLNA player 32 of from the cell phone 20. The tablet 30 can support or loop with multiple cellular devices at the same time. In one embodiment the tablet PC or automotive display 30 can connect with five devices 35 that are switch between by sweeping/sliding the screen display. The application launcher and manager 55 allows for transfer of data between the multiple looped cell phone(s) 20. A cell phone 20 can be deleted from looping with the tablet 30 by sliding the cell phone into the delete zone 57 on the main screen. The home screen of the tablet, PC or automotive display 30 is the user's first impression of the system and the system with the home screen can be customized by modifying the home screen to suit the desires of the user(s) in a method that is similar to customizing the screen of a smart phone, tablet, automobile display or PC. The term automotive display can be a dashboard, GPS, radio, monitor and or heads-up display device that is integrated or added to a transportation vehicle.

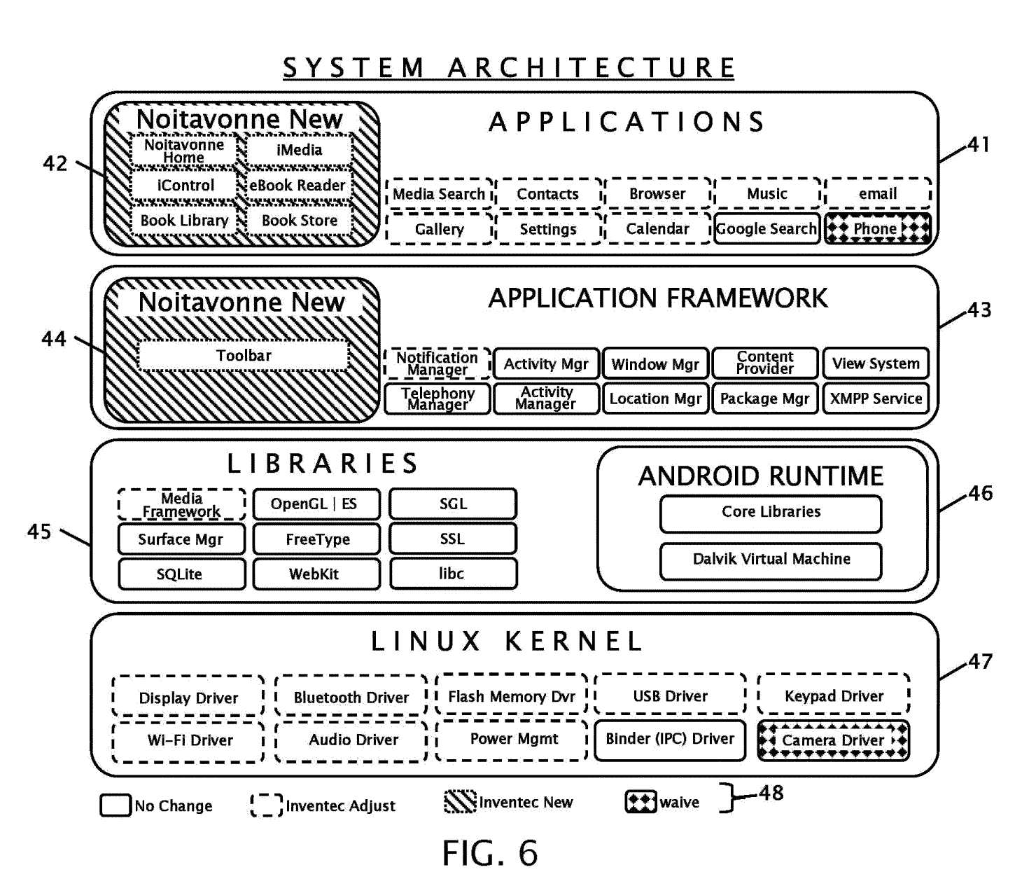

FIG. 6 shows a block diagram of the system architecture that includes applications 41, application framework 43, libraries 46 and Linux Kernels 47. A legend 48 at the bottom of this figure shows the components that were not changed, adjusted by Inventec, created as a new element by Inventec, and passed through or waved. Within the applications 41, Inventec added new components including Noitavonne home, iMedia, iControl that allows for control of remote control devices such as TV, VCR, DVD players and other remote control devices. Also included are a reader application, eBook Reader, Book Library, and book store for reading books, periodicals, newspapers and other written and e-documents. The applications that were adjusted include Media search, contacts, browser, music, email, picture gallery, settings and calendar. The Google search remains essentially unchanged. Within the Application framework the notification manager was modified but the activity manager, window manager, content provider, view system, telephony manager, activity manager, location manager, package manager and XMPP service. The Android runtime with the core libraries and the Dalvik virtual machine are unchanged. In the libraries 45, the media framework is modified but the openGL ES, SGL, surface manager, freetype, SSL, SQlite, Webkit and libc are unchanged. Within the Linux Kernel 47 the binder (IPC) driver is unchanged but the display driver, Bluetooth driver, flash memory driver, USB driver, keypad driver, Wi-Fi driver, audio driver and the power management was modified.

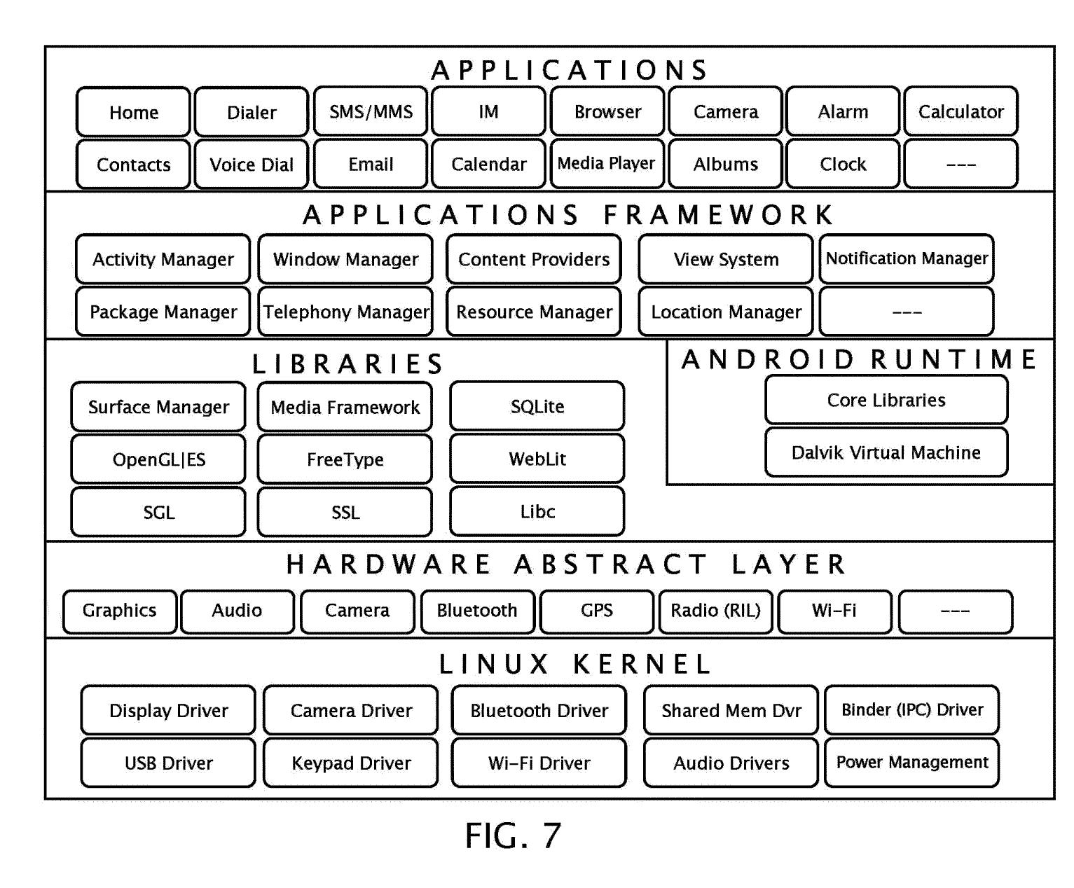

FIG. 7 shows a block diagram of the operating applications and where the software/hardware features were developed to interface between the cellular phone and the tablet to communicate through the loop.

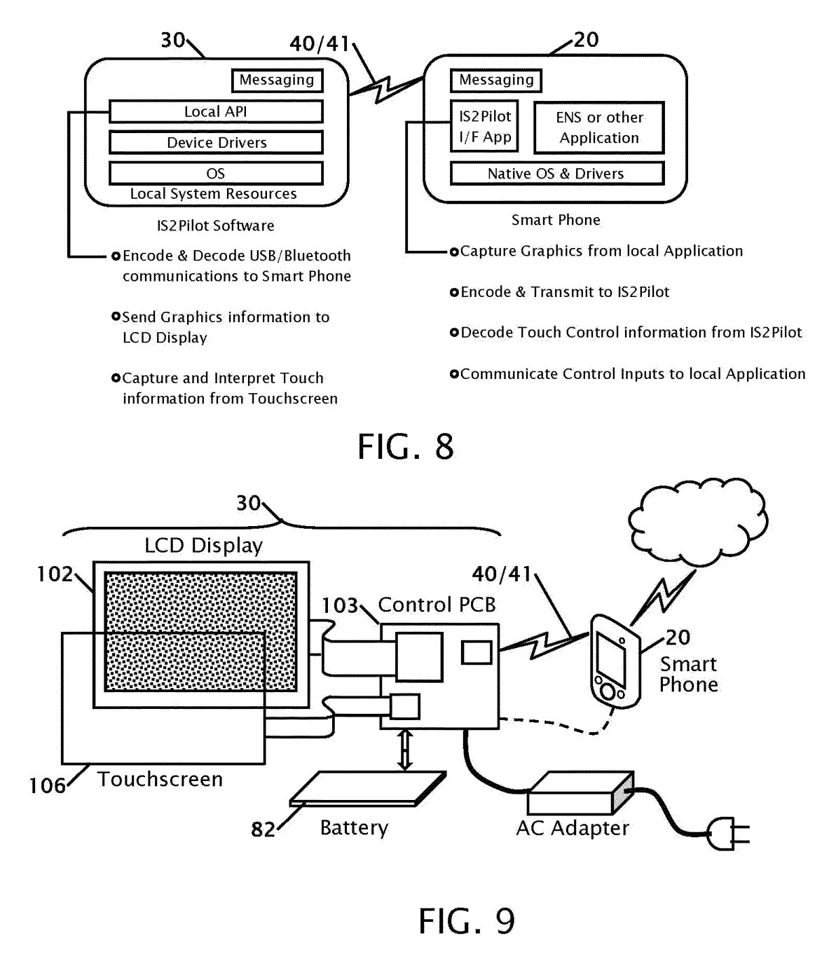

FIG. 8 shows a block diagram of the system Firmware/software architecture, and FIG. 9 shows a block diagram of the system hardware. In FIG. 8 the block diagram of the smart phone is shown, and the tablet device is shown in the left blocks. The communication 40/41 between the smart phone and the tablet can link to the internet through a Bluetooth, IR, RF, wired, Wi-Fi, G3, G4 or other wireless internet connection, while the computing device can be looped to the phone using a Wi-Fi connection at a coffee shop on the other side of the world. The smart phone allows messaging, capturing graphics from local application(s), encode and transmit the data to IS2pilot, loop veta or Noitavonne to decode touch control information from the IS2pilot and communicate control inputs to local applications. The data is received by the tablet. PC or vehicle display 30. The table, PC or vehicle display 30 encodes and decodes information and uses USB, Bluetooth or other previously disclosed or functionally equivalent methods to communicate with the smart phone 20. Graphic information is sent to the LCD display, capturing and interpreting touch information from the touch screen and communicating information and or data to the smart phone 20. FIG. 9 shows a pictorial representation of some of the components including but not limited to the table, PC or vehicle display 30 with a display 102, touch screen 106, control board 103, battery 82, smart phone 20 and the communication 40/41 between the two devices.

External charging and connectivity can be made using a SD memory connector 89, DC power jack 84, mini USB port 88, headset jack that connects to an audio CODEC 80, and a micro HDMI 87. Other features can include an audio amplifier 79 with an integrated speaker 92. Power management 81 is integrated between battery 82 and the processor 70 with an on-off control switch 83. Sensors such as but not limited to light sensor 85, temperature sensors 86, gyro and compass are also contemplated. Current prototypes have been made using an Android operating system but other systems that operate under Windows, Blackberry, Apple and Linux and others contemplated. The tablet can have an IR sensor 53 and remote control that allows for reception and or control of IR devices such as but not limited TV control, lighting controls and garage remote controls.

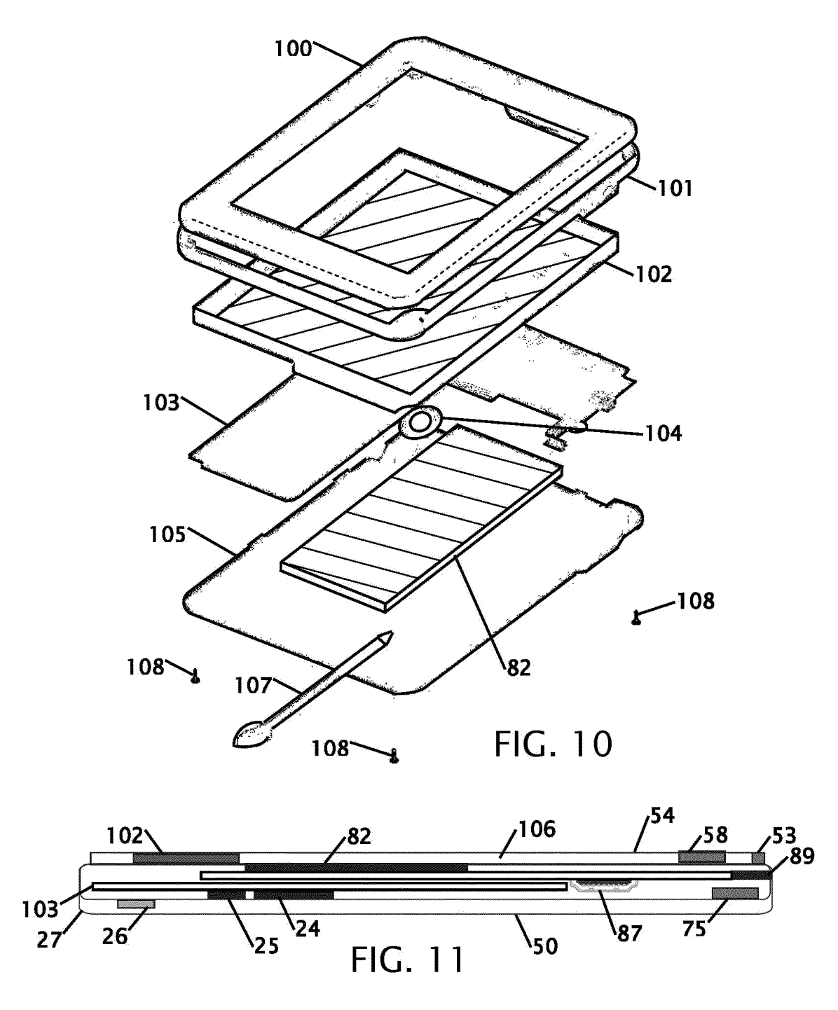

FIG. 10 shows an exploded view of a tablet computing device that can be looped to a cellular phone. A top bezel 100 surrounds side walls 101. The display 102 mounts into the top bezel 100. The circuit board 103 is visible with a cut-out for the battery 82. The back housing 105 secures the internal components with fasteners 108. User controls, buttons, lenses 104 and grills are also incorporated into the assembly as required along with a stylus 107.

FIG. 11 shows a side view with the controls and connection port In FIG. 11, the side view shows. While this side view shows a particular arrangement of components and features, it is one particular embodiment, but is not to be construed as the only contemplated embodiment. The connections and components in this embodiment include the main unit 103, a unit ID 27 and an internal battery pack 82. He tablet includes a front camera module 54 and a rear camera module 50. The display module 102 has a touchscreen overlay module 106 for user interface with a sensor PCB 58. Connections for insertable or external devices include but are not limited to Sin Card PCB 24, SD Card module 89 and connection for an external TV or other type of display 87. Wireless connections include 3G/4G 25, WLAN 75, IR Sensor 53 and Bluetooth 26.

FIG. 12 shows an assembled unit showing the display 71 with the external connection for a SD memory connector 89, DC power jack 84, mini USB port 88, Headset jack that connects to an audio CODEC 80, and a micro HDMI 87. Connection for external speakers or headphone 80. Volume 77 and on-off control switch with user interface buttons hard buttons 78. The camera or lens 73 is shown in the back housing 109 with the speaker grill 92 along with the opening for the IR sensor 53.

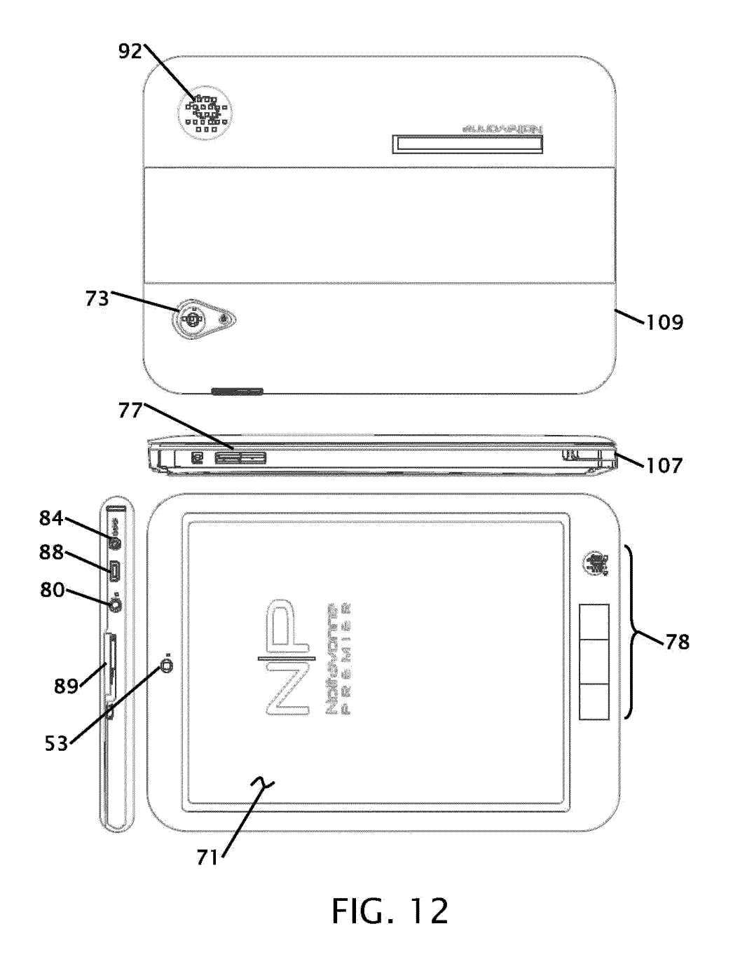

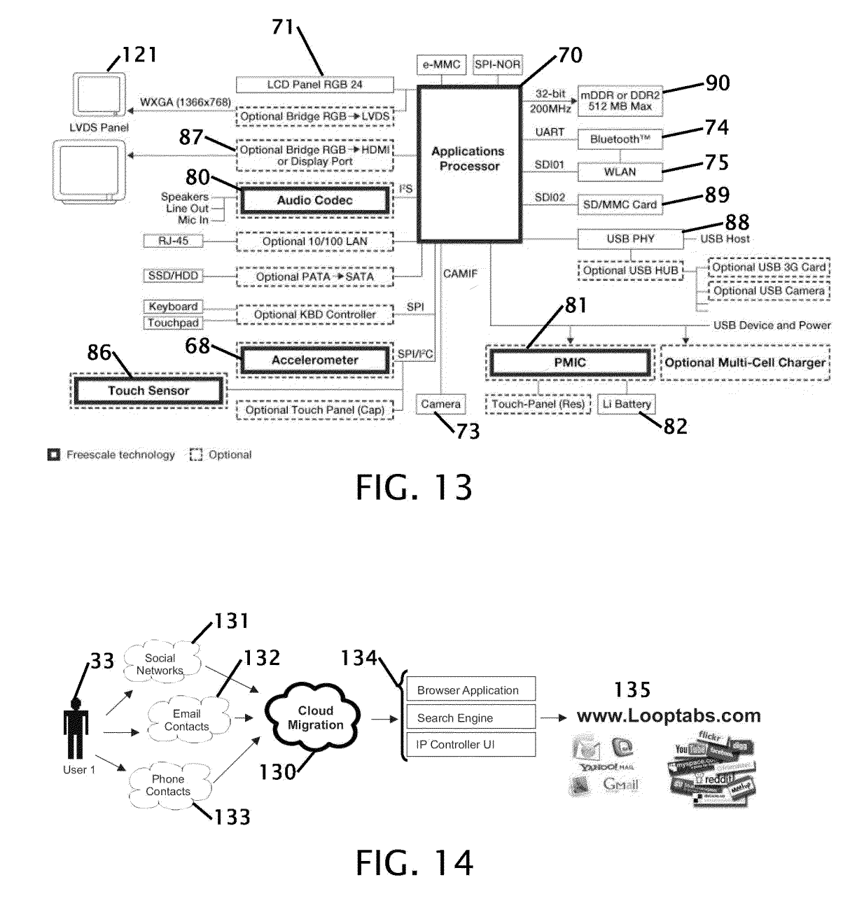

FIG. 13 shows a block diagram of tablet connections and hardware interfaces. Most of these interfaces are shown and described previously in FIG. 3. In this contemplated embodiment the CPU 70 is a single, dual or quad core processor. One form of memory 90 is contemplated as 2 GB or more of Flash storage. Another form of contemplated memory 90 is DDR2 Ram configures as 1 Gbits×4 (64M words×16 bits) or more. This embodiment shows an 8-inch TFT display 71 with a resolution of 800×600 SVGA with backlight controls having capacitive 86, resistive or inductive single or multi-touch sensitivity. Larger or smaller size displays with greater or lesser resolution are contemplated. Optional connections are for LVDS display 121 and or HDMI connections 87. Still and or VGA movie camera(s) 73 is also contemplated.

Options for connection to the tablet are contemplates as being with HSUPA, HSDPA, UMTS, WCDMA 3G modem module, Bluetooth 74, USB 88 and Wireless Connectivity IEEE802.11b/g/n Wireless LAN 75. Options for BT2.1 as well as GPS can be integrated. A variety of clocks for internal processing, time keeping and communications are contemplated. An audio Codec 80 provides processing of audio files that can be heard through integrated speakers or through a headphone jack. An Accelerometer 68, GPS and or compass determines the position of the tablet to determine screen position and operate as a user interface. Power to the tablet is provided by the battery 82 through a PMIC power management.

FIG. 14 shows a pictorial diagram of the tablet interfacing with other engines. A typical user 33 has needs to communicate into and through a variety of channels including but not limited to Social Networks 131, Email Contacts 132 and Phone Contacts 133. All of these channels communicate with cloud migration 130 through browser application(s), Search engine(s) and IP controller interface(s) 134. Through the website the communication from all of these sights is routed into the user's tablet through www.Looptabs.com 135 or through a similar connection/router/URL/interface.

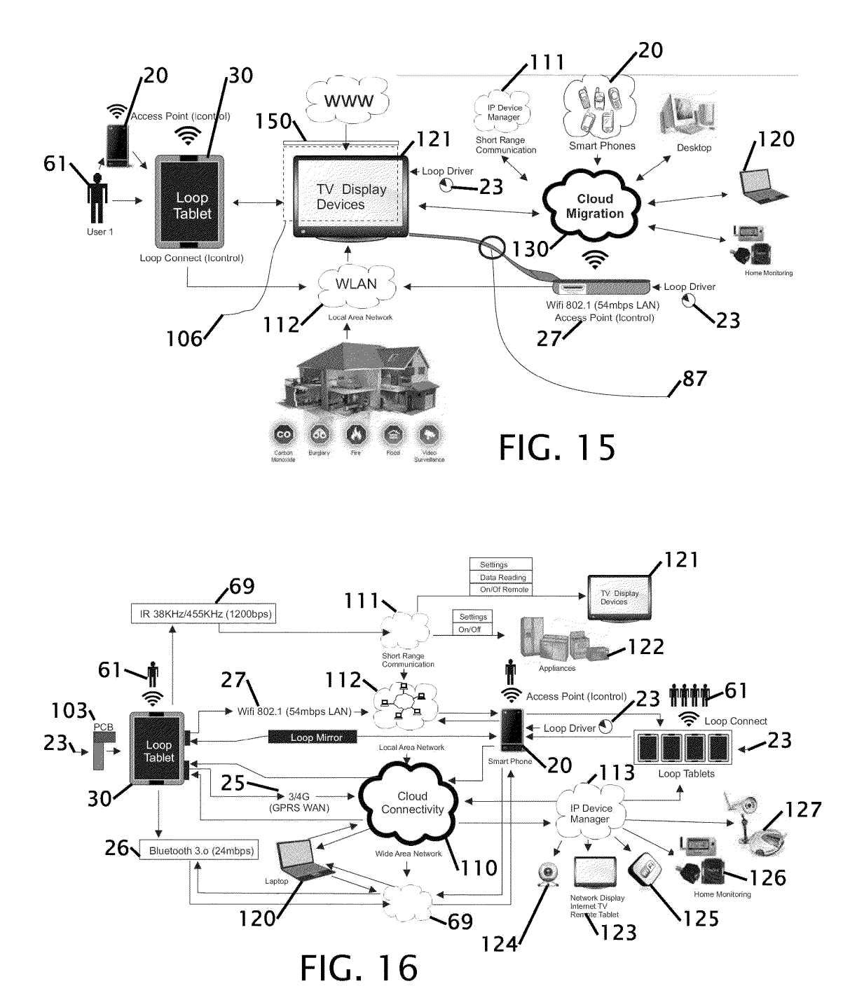

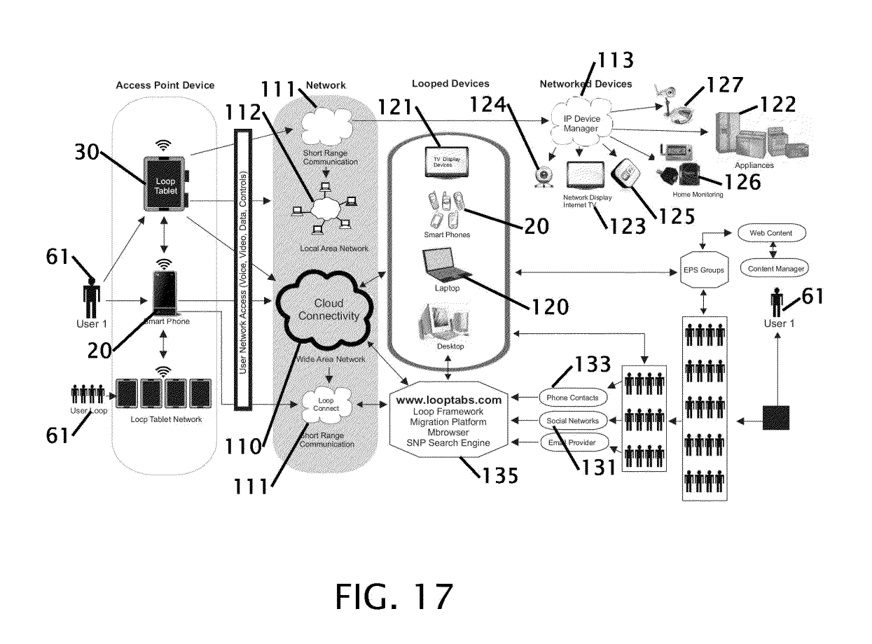

FIG. 15 shows a pictorial diagram of user's tablet with connection/interface options, FIG. 16 shows a pictorial diagram of the tablet connection interfacing and FIG. 17 shows a pictorial diagram of tablet(s) access to a network and other devices and people. Most people today have a cell phone 20. A majority of these users 61 will keep their cell phones 20 in proximity to them for the majority of the day. A typical cell phone user may also utilize a computing device such as a tablet 30, PC, automotive display, laptop 120, television 121 or other device throughout the day at their home, office or on the road. The loop allows a user to loop the phone features and functions to one or more of the computing devices using the lop network without direct physical interfacing with the cell phone 20. All or the majority of the phones features are available through the loop network.

A loop driver 23 operates over the network and or devices and or with a software, hardware or circuitry on a PCB 103. In the embodiment shown in FIG. 16, the loop driver 23 is in a PCB 103 that is installed in a loop tablet 30 and in the cell phone 20. In FIG. 15, the loop driver is in a TV Display Device 121. These devices, communicate through a variety of methods depending upon the communication methods that are available to the device(s). The contemplated communication methods include but are not limited to 3G/4G 25, Bluetooth 26, Wi-Fi 27, IR 69, WLAN 112 and wired. While these communication methods are contemplated and disclosed other currently available and in development methods can be used to provide equivalent functionality.

The communication enters the network 111, local area network 112, cloud connectivity 110, networked devices 113. While this network may be identified by a variety of names they all provide a connection to the service provider host at www.Looptabe.com 135 or equivalent that routs the information from one of the user's devices, such as a cell phone 20 to a tablet 30, automobile, or computer 120 and or TV or other looped device.

In FIG. 15, the TV (or computer) display device 121 has a drape device 150 with a touch screen 106 that allows communication though a connector such as an HDMI/VGA connector 87 to allow access 27 and communication through the Loop driver 23. An ID device manager provides control and access to network display 123, internet TV, remote devices, camera 124, Wi-Fi 125, home security 126 and gaming devices 127. Through the Loop website interface 135, the user 61 has access to all of their phone contacts 133, social networks 131 and email providers. It is also contemplated that the through the loop driver a user 61 can control other household devices and appliances 122 such as, but not limited to, refrigerators, ranges, washers, air conditioners, HVAC, VCR, DVD, cable boxes and others.

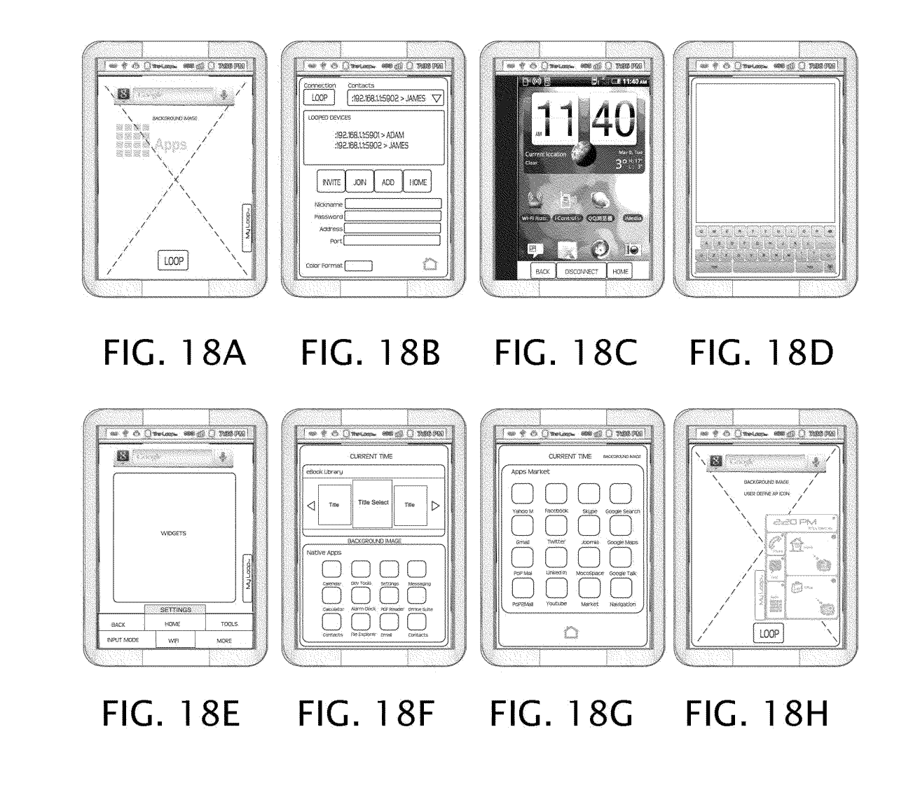

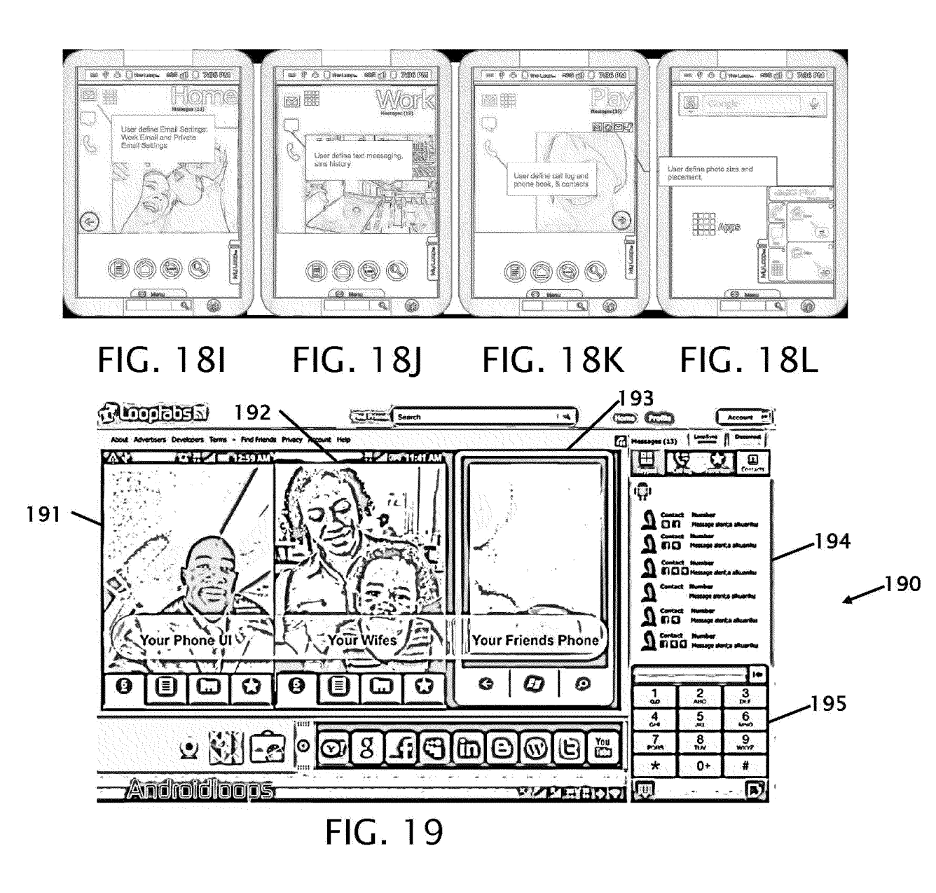

FIG. 18A-18L show twelve different screen display options. The screen display in FIG. 18A shows the available applications. FIG. 18B shows entry of a contacts entry screen. FIG. 18C shows an entry or initial screen. FIG. 18D shows a typing or keyboard entry screen. FIG. 18E shows a setting or widgets screen. FIG. 18F shows an eBook and setting screen. FIG. 18G shows available applications screen. FIG. 18H shows a connection with the Tablet Loop network. FIG. 18I shows the tablet looped to a home network. FIG. 18J shows the tablet looped to a worksite office. FIG. 18K shows the tablet looped to a social network with friends. FIG. 18L shows the tablet screen with access to the connections shown in FIGS. 18I, 18J and 18K. These screens can be connected and viewed simultaneously on a PC over the internet as shown in FIG. 19.

FIG. 19 shows computer screen 190 with three looped devices shown on the same screen. This figure shows camera view from a phone 191 with a view from a home 192 and with friends 193. The screen further allows access to the user's phone with contacts 194 and a phone dialing keypad 195.

Thus, specific embodiments of a smart phone companion loop have been disclosed. It should be apparent, however, to those skilled in the art that many more modifications besides those described are possible without departing from the inventive concepts herein. The inventive subject matter, therefore, is not to be restricted except in the spirit of the appended claims.

1. A smart phone companion loop comprising:
a cellular linked communication device;
a separate computing device;
a communication loop between said cellular linked device and said separate computing device whereby real-time bidirectional display and control is enabled between said cellular linked device and said separate computing device.

2. The smart phone companion loop according to claim 1 wherein said cellular linked communication device is a cellular phone with a display.

3. The smart phone companion loop according to claim 2 wherein said display is visible in a larger format on said separate computing device.

4. The smart phone companion loop according to claim 3 wherein said communication loop allows virtual access to functions of said cellular phone.

5. The smart phone companion loop according to claim 1 wherein said real-time bidirectional link is through IP, wireless, Wi-Fi, IR, FM or Bluetooth.

6. The smart phone companion loop according to claim 1 wherein said loop provides functionality between said cellular linked device and said separate computing device for display, user interface, camera, video, phone calls, games, text messaging, Internet access and social networking.

7. The smart phone companion loop according to claim 1 wherein said communication loop is through a cloud based connection.

8. The smart phone companion loop according to claim 1 wherein said communication link is through the internet.

9. The smart phone companion loop according to claim 1 wherein said separate computing device is a tablet, personal computer or automobile display.

10. The smart phone companion loop according to claim 1 wherein said separate computing device is a TV or video display device.

11. The smart phone companion loop according to claim 10 wherein said TV or video display device further includes a user interface.

12. The smart phone companion loop according to claim 11 wherein said user interface is a touch screen.

13. The smart phone companion loop according to claim 1 wherein functions of said separate computing device are accessible on said cellular linked communication device.

14. The smart phone companion loop according to claim 1 wherein said separate computing device can display a screen of more than one cellular linked communication devices at the same time.

15. The smart phone companion loop according to claim 1 wherein said computing device includes at least one of a touch screen, accelerometer and audio codec.

16. The smart phone companion loop according to claim 1 wherein said communications loop allows for control of at least one of a TV, video device, audio device and a recording device.

17. The smart phone companion loop according to claim 1 wherein said communications loop allows for control of at least one of a refrigerator, an air conditioner, a HVAC unit, an oven and a home security device or sensor.

18. The smart phone companion loop according to claim 1 wherein said communications loop is with a loop driver that is present in all devices communication over said communications loop.

19. The smart phone companion loop according to claim 1 wherein selection of operation or functions on said cellular linked communication device is communicated over said communication loop and operate functions on said separate computing device.

20. The smart phone companion loop according to claim 1 wherein selection of operation or functions on said separate computing device is communicated over said communication loop and operate functions on said cellular linked communication device.
